(19) United States
(12) Patent Application Publication
(10) Pub. No.: US 2008/0080744 A1
(43) Pub. Date: Apr. 3, 2008

(54) Face Identification Apparatus and Face Identification Method

(75) Inventor: Shoji Tanaka, Tokyo (JP)

Correspondence Address: BIRCH STEWART KOLASCH & BIRCH, PO BOX 747, FALLS CHURCH, VA, 22040-0747, US

(73) Assignee: MITSUBISHI ELECTRIC CORPORATION, CHIYODA-KU, TOKYO (JP)

(21) Appl. No.: 11/659,665

(22) PCT Filed: Sep. 17, 2004
(86) PCT No.: PCT/JP04/13666

§ 371 Date: Feb. 7, 2007

(51) Int. Cl. G06K 9/00

(52) U.S. Cl. 382/118

(57) ABSTRACT

A feature-quantity-extraction image generating means 2 generates an image for feature quantity extraction in which a predetermined operation is performed on the value of each pixel from an inputted image. A face detecting means 3 and a both eyes detecting means 4 carry out detection of a person's face and both eyes on the basis of the image for feature quantity extraction. A feature quantity acquiring means 6 extracts a feature quantity from the image which is normalized on the basis of the positions of the person's both eyes. A face identification means 10 carries out identification of the person's face by comparing the feature quantity acquired by the feature quantity acquiring means 6 with feature quantities which are registered in advance.

### FIELD OF THE INVENTION

The present invention relates to a face identification apparatus for and a face identification method of extracting a face region from an image which was obtained by shooting a person's face, and comparing an image of this face region with pre-registered data so as to identify the person's face.

### BACKGROUND OF THE INVENTION

When detecting a face region from an inputted image of a person's face, a prior art face identification apparatus Fourier-transforms the values of all pixels included in a circle whose center is located at a point midway between the person's eyes so as to acquire, as a face region, a region having a frequency of 2. When carrying out face identification, the prior art face identification apparatus uses a feature quantity which it has extracted from the face region using a Zernike (Zernike) moment (for example, refer to patent reference 1).

### [Patent Reference 1] JP,2002-342760,A

However, because the above-mentioned prior art face identification apparatus Fourier-transforms the values of all pixels included in a circle whose center is located at a point midway between the person's eyes so as to determine, as the face region, a region having a frequency of 2, when detecting the face region from the inputted image, it is difficult for the prior art face identification apparatus to determine the face region correctly in a case in which the person's eyebrows are covered by the hair in the image, for example.

Another problem with the prior art face identification apparatus is that even if it can identify the person using the image of the person's face, there is a large amount of arithmetic operation because, for example, a complicated arithmetic operation is needed to calculate a Zernike moment which is used for identification of the person, the cost of calculations is high in, for example, a mobile phone or a PDA (Personal Digital Assistants) having an arithmetic operation capability on which some restrictions are imposed, and it is therefore difficult to implement real-time processing.

The present invention is made in order to solve the above-mentioned problems, and it is therefore an object of the present invention to provide a face identification apparatus and a face identification method capable of extracting a face region correctly even from any of various face images, and of reducing the amount of arithmetic operations.

### DISCLOSURE OF THE INVENTION

In accordance with the present invention, there is provided a face identification apparatus including: a feature-quantity-extraction image generating means for performing a predetermined operation on each pixel value of an inputted image so as to generate an image for feature quantity extraction; a face detecting means for detecting a face region including a person's face from the image for feature quantity extraction; a both eyes detecting means for detecting positions of the person's both eyes from the image for feature quantity extraction; a feature quantity acquiring means for extracting a feature quantity from the image in which the face region is normalized on the basis of the positions of the person's both eyes; and a face identification means for comparing the feature quantity acquired by the feature quantity acquisition means with persons' feature quantities which are registered in advance so as to identify the person's face.

As a result, the reliability of the face identification apparatus can be improved, and the amount of arithmetic operations can be reduced.

### BRIEF DESCRIPTION OF THE FIGURES

FIG. 1 is a block diagram showing a face identification apparatus in accordance with embodiment 1 of the present invention;

FIG. 2 is a flow chart showing the operation of the face identification apparatus in accordance with embodiment 1 of the present invention;

FIG. 3 is an explanatory diagram showing a relation between an original image inputted to the face identification apparatus in accordance with embodiment 1 of the present invention, and an integral image obtained by the face identification apparatus;

FIG. 4 is an explanatory diagram showing a method of splitting the image into image parts and processing them which the face identification apparatus in accordance with embodiment 1 of the present invention uses;

FIG. 5 is an explanatory diagram of a rectangle filter of the face identification apparatus in accordance with embodiment 1 of the present invention;

FIG. 6 is an explanatory diagram of a process of calculating the sum of the values of pixels of the face identification apparatus in accordance with embodiment 1 of the present invention;

FIG. 7 is an explanatory diagram of a process of calculating the sum of the values of all pixels included in a rectangle in a case in which an integral image is acquired for each of the split image parts by the face identification apparatus in accordance with embodiment 1 of the present invention;

FIG. 8 is an explanatory diagram of a search block which is a target for face region detection when the face identification apparatus in accordance with embodiment 1 of the present invention detects a face region;

FIG. 9 is a flow chart showing a process of detecting the face region of the face identification apparatus in accordance with embodiment 1 of the present invention;

FIG. 10 is an explanatory diagram showing a result of the detection of the face region of the face identification apparatus in accordance with embodiment 1 of the present invention;

FIG. 11 is an explanatory diagram of searching of both eyes of the face identification apparatus in accordance with embodiment 1 of the present invention;

FIG. 12 is an explanatory diagram of an operation of searching for an eye region of the face identification apparatus in accordance with embodiment 1 of the present invention;

FIG. 13 is an explanatory diagram of normalization processing of the face identification apparatus in accordance with embodiment 1 of the present invention; and

FIG. 14 is an explanatory diagram of a feature quantity database of the face identification apparatus in accordance with embodiment 1 of the present invention.

### PREFERRED EMBODIMENTS OF THE INVENTION

Hereafter, in order to explain this invention-in greater detail, the preferred embodiments of the present invention will be described with reference to the accompanying drawings.

### Embodiment 1.

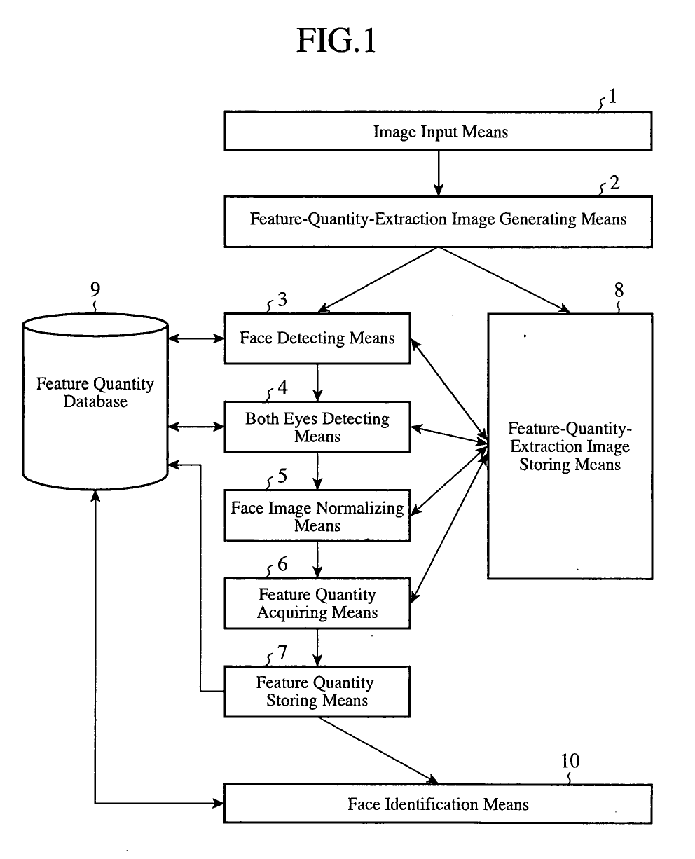

FIG. 1 is a block diagram showing a face identification apparatus in accordance with embodiment 1 of the present invention.

The face identification apparatus in accordance with this embodiment is provided with an image input means 1, a feature-quantity-extraction image generating means 2, a face detecting means 3, a both eyes detecting means 4, a face image normalizing means 5, a feature quantity acquiring means 6, a feature quantity storing means 7, an image storing means 8 for feature quantity extraction, a feature quantity database 9, and a face identification means 10.

The image input means 1 is a functional unit for inputting an image, and consists of, for example, a digital camera mounted in a mobile phone, a PDA, or the like, a unit for inputting an image from an external memory or the like, or an acquiring means for acquiring an image from the Internet using a communications means.

The feature-quantity-extraction image generating means 2 is a means for performing a predetermined operation on the value of each pixel of the image inputted by the image input means 1 so as to acquire an image for feature quantity extraction. The image for feature quantity extraction is, for example, an integral image, and will be mentioned below in detail.

The face detecting means 3 is a functional unit for detecting a face region including a person's face on the basis of the image for feature quantity extraction generated by the feature-quantity-extraction image generating means 2 using a predetermined technique. The both eyes detecting means 4 is a functional unit for detecting a both eyes region including the person's both eyes from the face region using the same technique as that which the face detecting means 3 uses. The face image normalizing means 5 is a functional unit for enlarging or reducing the face region so that it has an image size which is suited for a target of face identification on the basis of the positions of the person's both eyes detected by the both eyes detecting means 4. The feature quantity acquiring means 6 is a functional unit for acquiring a feature quantity for face identification from the face image which has been normalized by the face image normalizing means, and the feature quantity storing means 7 is a functional unit for sending the feature quantity to the feature quantity database 9 and face identification means 10.

The feature-quantity-extraction image storing means 8 is a functional unit for stores the image for feature quantity extraction generated by the feature-quantity-extraction image generating means 2, and the face detecting means 3, both eyes detecting means 4, face image normalizing means 5, and feature quantity acquiring means 6 are constructed so that they can carry out various processings on the basis of the image for feature quantity extraction stored in this feature-quantity-extraction image storing means 8. The feature quantity database 9 is the one for storing the feature quantities of persons' faces which the face detecting means 3 uses, the feature quantities of persons' both eyes which the both eyes detecting means 4 uses, and the feature quantities of persons which the face identification means 10 uses. The face identification means 10 is a functional unit for comparing the feature quantity of the person's face which is a target for identification, the feature quantity being acquired by the feature quantity acquiring means 6, with the feature quantity data about each person's face which is pre-registered in the feature quantity database 9 so as to identify the person's face.

Next, the operation of the face identification apparatus in accordance with this embodiment will be explained.

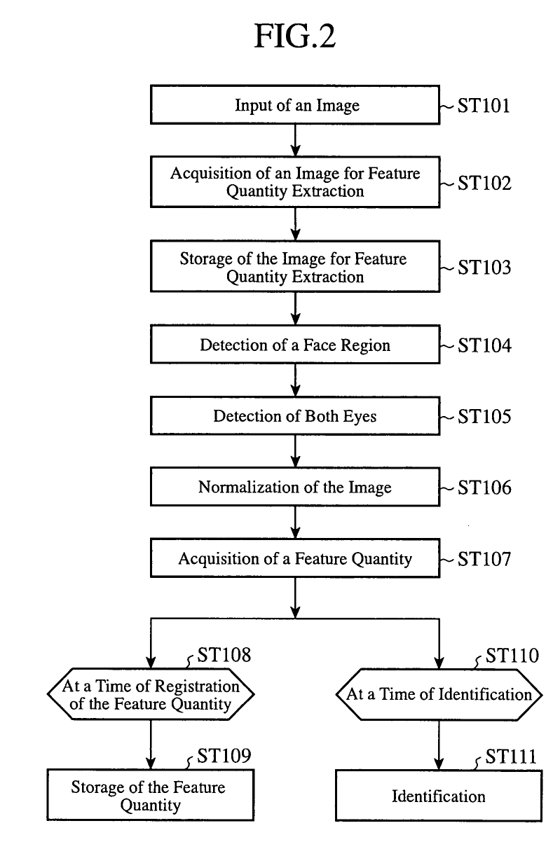

FIG. 2 is a flow chart showing the operation of the face identification apparatus.

First, the image input means 1 inputs an image (in step ST101). In this embodiment, the image input means can accept any type of an image which can be inputted into a mobile phone, a PDA, or the like, such as an image captured using a digital camera mounted in a mobile phone, a PDA, or the like, an image inputted from an external memory or the like, or an image acquired from the Internet or the like using a communications means.

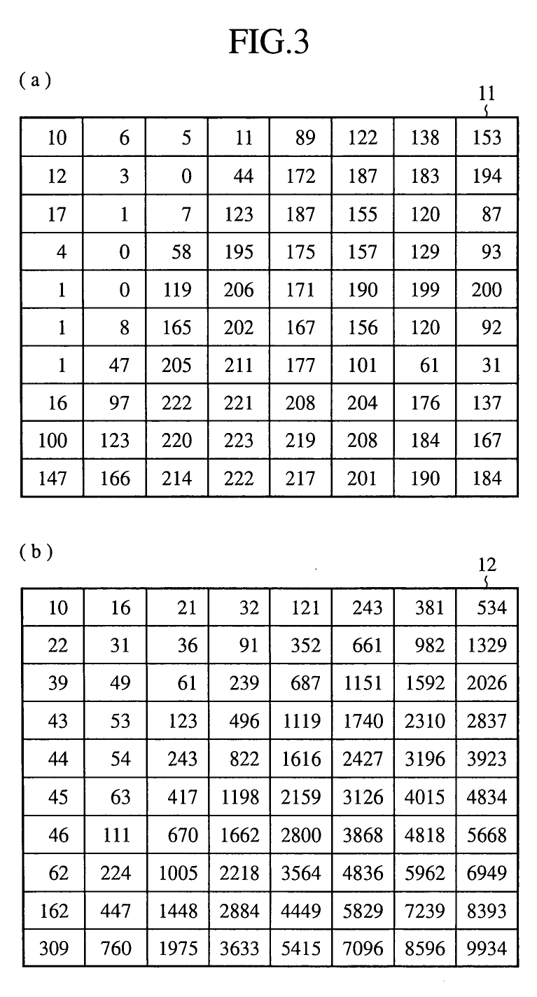

Next, the feature-quantity-extraction image generating means 2 acquires an image for feature quantity extraction (in step ST102). In this embodiment, the image for feature quantity extraction is an image which is used when filtering the inputted image with a filter called a Rectangle Filter (rectangle filter) which is used to extract a feature when performing each of detection of a person's face, detection of the person's both eyes, and identification of the person's face. For example, the image for feature quantity extraction is an integral image in which each pixel has a value which is obtained by summing the values of pixels running in the directions of the x-axis and/or y-axis of the image (i.e., in the directions of the horizontal axis and/or vertical axis of the image), as shown in FIG. 3.

The integral image can be acquired using the following equation.

When a gray-scale image is given by I (x, y), an integral image I′ (x, y) of the gray-scale image can be expressed by the following equation:

$${I}^{′} ( x , y ) = {\sum }_{{y}^{′} \leq y - 1} {\sum }_{{x}^{′} \leq x - 1} I ( {x}^{′} , {y}^{′} ) \qquad [ Equation 1 ]$$

FIG. 3 is an explanatory diagram showing a result of conversion of the original image into the integral image by means of the feature-quantity-extraction image generating means 2.

For example, the integral image 12 into which the original image 11 is converted is the one as shown in the figure. In other words, each pixel of the integral image 12 corresponding to each pixel value of the original image 11 has a value which is obtained by summing the values of all pixels starting from the pixel at the top-left vertex of the original image and ending at the corresponding pixel of the original image and running in the directions of the horizontal axis and/or vertical axis.

An integral image can be obtained from a gray-scale image. Therefore, in a case in which the inputted image is a color image, an integral image is obtained after the value of each pixel of the inputted image is converted using the following equation.

When the R component, G component, and B component of each pixel of a color image are expressed as Ir, Ig, and Ib, a gray-scale I is acquired using, for example, the following equation:

I(x,y)=0.2988Ir(x,y)+0.5868Ig(x,y)+0.1144Ib(x,y)

As an alternative, the average of the RGB components can be obtained.

In a case in which the inputted image which the image input means 1 receives has a big size, such as a 3-million-pixel size, there is a possibility that the values of some pixels of the integral image cannot be expressed by integer-type data which is used to express the value of each pixel of the integral image. That is, some pixels of the integral image may overflow a maximum data size of integer type.

Therefore, in accordance with this embodiment, taking such a case into consideration, the image is split into some parts in the following way so that the value of each pixel of an integral image of each split part does not overflow, and the integral image of each split part is thus obtained.

In this embodiment, each pixel of the integral image 12 has a value which is obtained by summing the values of pixels of the original image 11, just as they are. As an alternative, each pixel of the integral image 12 can have a value which is obtained by summing the square of the value of each corresponding pixel of the original image 11. The present invention can be similarly applied to this case. In this case, in order to prevent the value of each pixel of the integral image of each divided part from overflowing the maximum data size of integer type, the number of parts into which the original image is split is increased (i.e., the size of each split image is reduced).

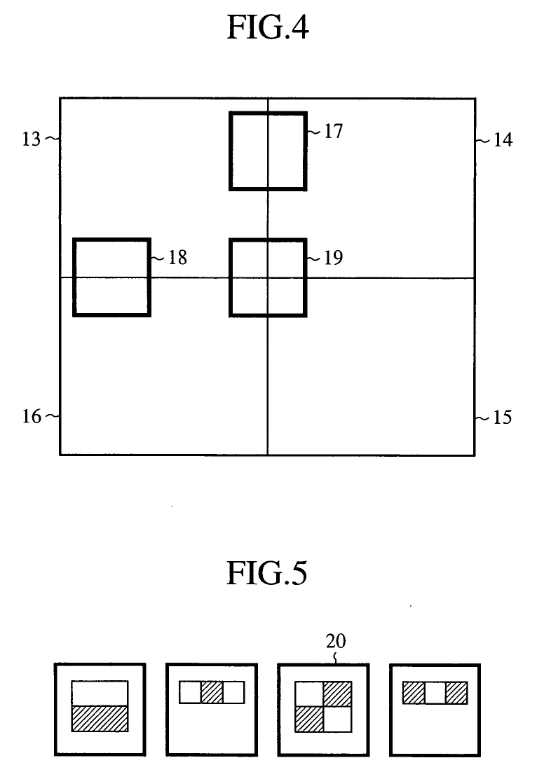

FIG. 4 is an explanatory diagram showing a method of splitting the original image into some parts, and processing each split image.

In the figure, reference numerals 13 to 16 denote the split images, respectively, and reference numerals 17 to 19 denote cases in each of which a search window overlaps two or more of the split images.

Thus, in accordance with this embodiment, an integral image is acquired for each of the split image parts 13, 14, 15, and 16. There are cases in which a rectangle in which the values of all pixels included are summed extends over two or more of the split image parts. There can be the following three cases: the case 18 in which the rectangle extends over two different split image parts running in the vertical direction, the case 17 in which the rectangle extends over two different split image parts running in the horizontal direction, and the case 19 in which the rectangle extends over the four different split image parts. A processing method for each of these cases will be mentioned below.

After acquiring the integral image for each of the split image parts in this way, the face detecting means 3 detects a face region from the image (in step ST104).

In the face identification apparatus in accordance with this embodiment, the features of the person's face, the features of the person's eyes, and the features of the person's individual variation in his or her face are all expressed by a combination of response values which are obtained after filtering the image using a plurality of Rectangle Filters 20 shown in FIG. 5.

Each Rectangle Filter 20 shown in FIG. 5 subtracts the sum of the values of all pixels in one or more hatched rectangles from the sum of the values of all pixels in one or more hollow rectangles in the search block of a fixed size, for example, a 24×24-pixel block.

That is, each Rectangle Filter 20 outputs, as a response thereof, the subtraction result expressed by the following equation:

RF=Σ^{I}(x_{w},y_{w})−Σ^{I}(xₕ,yₕ) Equation 2

where I(x_{w},y_{w}) is the sum of the values of all pixels in one or more hollow rectangles in the search block, and I(x_{b},y_{b}) is the sum of the values of all pixels in one or more hatched rectangles in the search block.

The Rectangle Filters 20 shown in FIG. 5 are basic ones. In practical cases, there can be further provided a plurality of Rectangle Filters 20 having hatched and hollow rectangles whose positions and sizes differ from those of the above-mentioned examples.

The face detecting means 3 assigns weights to a plurality of filtering response values which are obtained by filtering the image using a plurality of Rectangle Filters suitable for detecting the person's face, respectively, and then determines whether or not the search block is the face region by determining whether or not the linear sum of the weights is larger than a threshold. That is, the weights respectively assigned to the plurality of filtering response values show the features of the person's face. These weights are predetermined using a learning algorithm or the like.

That is, the face detecting means determines whether or not the search block is the face region using the following discriminant:

$$F = {\sum }_{i ∈ ∀} {RFw}_{i} \\ \{ \begin{matrix}F > th : Face \\ F \leq th : nonFace\end{matrix} \qquad [ Equation 3 ]$$

where RFwᵢ shows the weight assigned to the response of each of the Rectangle Filters, F shows the linear sum of the weights, and th shows the face judgment threshold.

The face detecting means 3 carries out the detection of the person's face on the basis of the sum of the values of all pixels included in each rectangle within the search block in the above-mentioned way. At that time, the face detecting means uses the integral image which is acquired by the feature-quantity-extraction image generating means 2 as a means for carrying out an arithmetic operation of calculating the sum of the values of all pixels included in each rectangle efficiently.

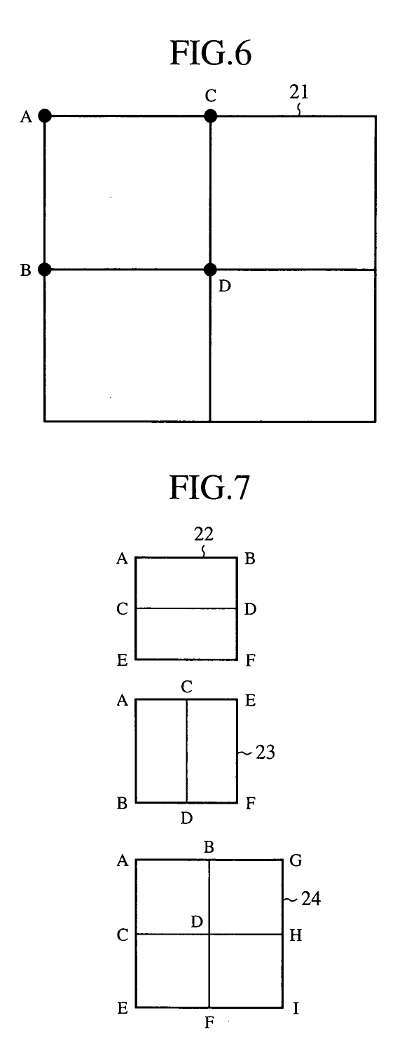

For example, in a case of summing the values of all pixels in a rectangle, as shown in FIG. 6, which is surrounded by points A, B, C, and D in a region 21, the face detecting means can calculate the sum of the values of all pixels in the rectangle using the integral image according to the following equation:

S=Int(x_{d},y_{d})−Int(x_{b},y_{b})−Int(x_{c},y_{c})+Int(xₐ,yₐ)
Int(x_{d},y_{d}): the integral (or sum) of pixel values at point D
Int(x_{b},y_{b}): the integral of pixel values at point B
Int(x_{c},y_{c}): the integral of pixel values at point C
Int(xₐ,yₐ): the integral of pixel values at point A

Thus, once the integral image is obtained, the sum of the values of all pixels in the rectangle can be usually calculated using only the calculation results at the four points. Therefore, the sum of the values of all pixels in an arbitrary rectangle can be calculated efficiently. Furthermore, because each pixel's integrated value of the integral image 12 is also expressed as an integer, it is possible to carry out the whole face identification processing of this embodiment including various processes using such the integral image 12 by performing only integer arithmetic operations.

As previously mentioned, in the case in which the image is split into several parts, and an integral image is acquired for each of the image parts, there are cases, as denoted by the reference numerals 17 to 19 in FIG. 4, in which the search block overlaps two or more of the split image parts, and therefore the sum of the values of all pixels in them must be calculated.

As previously mentioned, there can be the following cases in each of which the search block overlaps two or more of the split image parts: the case 18 in which the search block overlaps two split image parts running in the vertical direction, the case 17 in which the search block overlaps two different split image parts running in the horizontal direction, and the case 19 in which the search block overlaps the four split image parts.

FIG. 7 is an explanatory diagram showing the three cases in each of which the search block overlaps two or more of the split image parts.

In the case in which the search block overlaps two split image parts running in the vertical direction, the sum of the values of all pixels in a rectangle ABEF designated by a reference numeral 22 in the figure can be calculated according to the following equation:

S=Int(x_{d},y_{d})+Int(xₐ,yₐ)−(Int(x_{b},y_{b})+Int(x_{c},y_{c}))+Int(x_{f},y_{f})+Int(x_{c},y_{c})−(Int(xₑ,yₑ)+Int(x_{d},y_{d}))
Int(x_{d},y_{d}): the integral of pixel values at point D
Int(x_{b},y_{b}): the integral of pixel values at point B
Int(x_{c},y_{c}): the integral of pixel values at point C
Int(xₐ,yₐ): the integral of pixel values at point A
Int(xₑ,yₑ): the integral of pixel values at point E
Int(x_{f},y_{f}): the integral of pixel values at point F

Also in the case in which the search block overlaps two split image parts running in the horizontal direction, the sum of the values of all pixels in the rectangle can be calculated in the same way as mentioned above. For example, the sum of the values of all pixels in a rectangle ABEF designated by a reference numeral 23 in the figure can be calculated according to the following equation:

S=Int(x_{d},y_{d})+Int(xₐ,yₐ)−(Int(x_{b},y_{b})+Int(x_{c},y_{c}))+Int(x_{f},y_{f})+Int(x_{c},y_{c})−(Int(xₑ,yₑ)+Int(x_{d},y_{d}))
Int(x_{d},y_{d}): the integral of pixel values at point D
Int(X_{b},y_{b}): the integral of pixel values at point B
Int(x_{c},y_{c}): the integral of pixel values at point C
Int(xₐ,yₐ): the integral of pixel values at point A
Int(Xₑ,yₑ): the integral of pixel values at point E
Int(x_{f},y_{f}): the integral of pixel values at point F

In the case in which the search block overlaps the four split image parts, the sum of the values of all pixels of parts of the search block which respectively overlap the four split image parts only has to be calculated. For example, the sum of the values of all pixels in a rectangle AGEI designated by a reference numeral 24 in FIG. 7 can be calculated according to the following equation:

S=Int(xₐ,yₐ)+Int(x_{d},y_{d})−(Int(x_{b},y_{b})+Int(x_{c},y_{c}))+Int(x_{c},y_{c})+Int(x_{f},y_{f})−(Int(x_{d},y_{d})+Int(xₑ,yₑ))+Int(x_{b},y_{b})+Int(xₕ,yₕ)−(Int(x_{d},y_{d})+Int(x_{g},y_{g}))+Int(x_{d},y_{d})+Int(xᵢ,yᵢ)−(Int(x_{f},y_{f})+Int(xₕ,yₕ))
Int(x_{d},y_{d}): the integral of pixel values at point D
Int(X_{b},y_{b}): the integral of pixel values at point B
Int(x_{c},y_{c}): the integral of pixel values at point C
Int(xₐ,yₐ): the integral of pixel values at point A
Int(Xₑ,yₑ): the integral of pixel values at point E
Int(x_{f},y_{f}): the integral of pixel values at point F
Int(x_{g},y_{g}): the integral of pixel values at point G
Int(Xₕ,yₕ): the integral of pixel values at point H
Int(xᵢ,yᵢ): the integral of pixel values at point I

Next, the size of the search block which is used for the above-mentioned extraction of the face feature quantity is usually fixed to, for example, a 24×24-pixel size. Therefore, an image of a person's face in a search block having such a size is used as a target for learning when learning of face feature quantities is performed. However, it is impossible to detect a face region having an arbitrary size from the captured image using the search block having a fixed size. In order to solve this problem, there can be provided a method of enlarging and reducing the captured image to create two or more images having different resolutions, or a method of enlarging or reducing the search block. Either of the methods can be used.

In this embodiment, because the memory efficiency is reduced in a case in which integral images are generated according to different resolutions, the method of enlarging or reducing the search block is used. That is, a face region having an arbitrary size can be detected by enlarging or reducing the search block with a fixed scaling factor as follows.

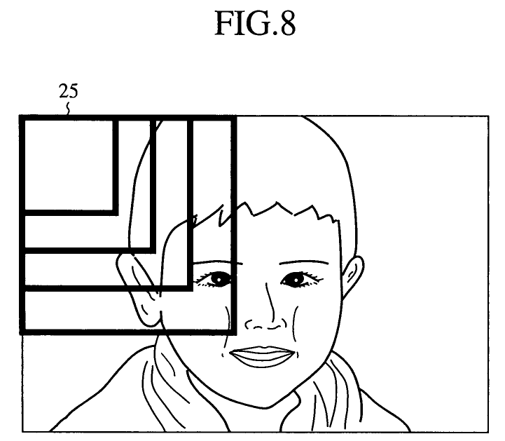

FIG. 8 is an explanatory diagram of the search block which is used as a target for face region detection when the face identification apparatus detects a face region.

The operation of detecting a face region by enlarging or reducing the search block 25 shown in the figure is performed as follows.

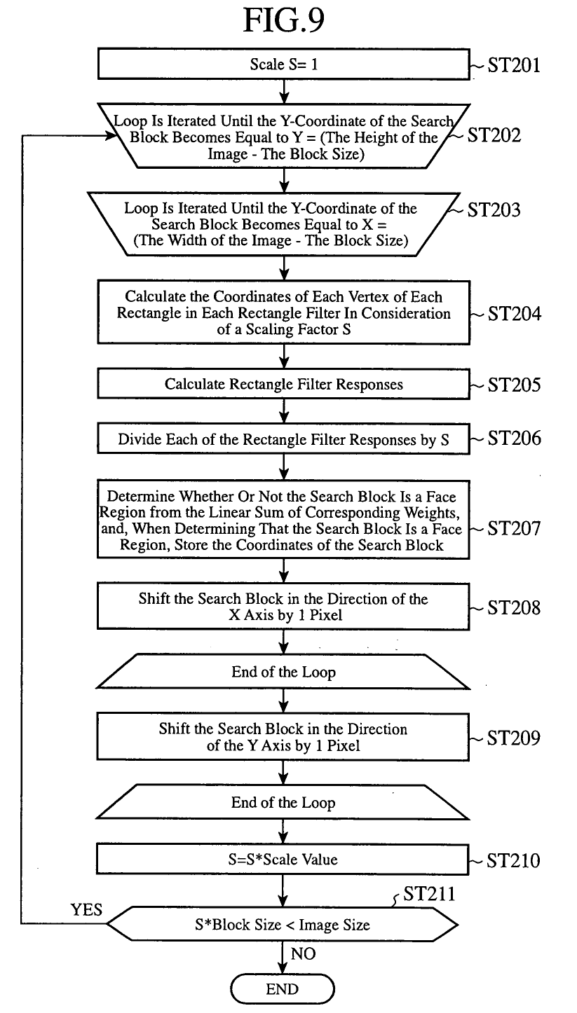

FIG. 9 is a flow chart showing the face region detection processing.

First, the scaling factor S is set to 1.0 , and the detection is started using the search block having a size equal to the original size (in step ST201).

In the face detection, it is determined whether or not the image of the search block is a face region by shifting the search block in the vertical or horizontal direction by 1 pixel at a time, and, when it is determined that the image is a face region, coordinates of the image are stored (in steps ST202 to ST209).

First, new coordinates of each rectangle in each Rectangle Filter (or the coordinates of vertexes which constructs each rectangle) are calculated by multiplying the coordinates of each rectangle by the scaling factor S (in step ST204).

A simply multiplication of the coordinates of each vertex of a rectangle by the scaling factor S causes a rounding error, and this results in erroneous coordinate values. Therefore, the calculation of the new coordinates of each vertex of every rectangle which is caused by the scaling of the search block is performed using the following equation:

$${r}_{N} = ( ( {r}_{C} + 1 ) \cdot S - 1 ) + ( \frac{( {r}_{C} - top )}{height} ) \cdot ( S \cdot height ) {c}_{N} = ( ( {c}_{C} + 1 ) \cdot S - 1 ) + ( \frac{( {c}_{C} - left )}{width} ) \cdot ( S \cdot width ) \qquad [ Equation 4 ]$$

In the above-mentioned equation, top is the Y coordinate of the top-left vertex of each rectangle, left is the X coordinate of the top-left vertex of each rectangle, height is the height of each rectangle, width is the width of each rectangle, S is the scaling factor, rc and cc are the coordinates of the original vertexes of each rectangle, and rn and cn are the coordinates of the new vertexes of each rectangle after enlarged or reduced.

The above-mentioned equation is not dependent on the coordinates of each rectangle, and is needed in order to always keep the size of each rectangle constant.

The face detecting means calculates a filter response for each filter on the basis of the integral image stored in the feature-quantity-extraction image storing means 8 using the coordinates calculated in the above-mentioned way (in step ST205). Because the rectangle is enlarged for this filter response, the filter response is increased by only the scaling factor compared with the value which is calculated using a search block size at the time of learning.

Therefore, by dividing the filter response by the scaling factor, as shown in the following equation, the value which can be calculated using the same search block size as that at the time of learning is acquired (in step ST206).

F=R/S

where F is the response, R is the response which is calculated from the enlarged rectangle, and S is the scale of enlargement.

The face detecting means calculates weights which correspond to the responses from the values calculated in the above-mentioned way, calculates a linear sum of all the weights, and determines whether or not the search block is a face by comparing the calculated value with a threshold (in step ST207). When determining that the search block is a face, the face detecting means stores the coordinates of the search block at that time.

After scanning the whole image, the face detecting means multiplies the scaling factor S by a fixed value, e.g. 1.25 (in step ST210), and repeats the processes of steps ST202 to ST209 with the new scaling factor. When the size of the enlarged search block then exceeds the size of the image, the face detecting means ends the face detection processing (in step ST211).

In the above-mentioned processing, when the scaling factor is expressed integrally, and, for example, 1.0 is replaced by 100, any integer less than 100 can be treated as a decimal. In this case, when multiplying two numbers together, the multiplication result is divided by 100. When dividing a number by another number, the number only has to be multiplied by 100 before the division. Thus, the above-mentioned calculations can be carried out without using decimals.

In the above-mentioned face region detection, because it is determined whether or not the search block is a face region by shifting the search block by 1 pixel , as mentioned above, the search block which is sequentially shifted in the vicinity of the face is determined to be a face region at two or more different positions, and therefore two or more face region rectangles which overlap one another are stored.

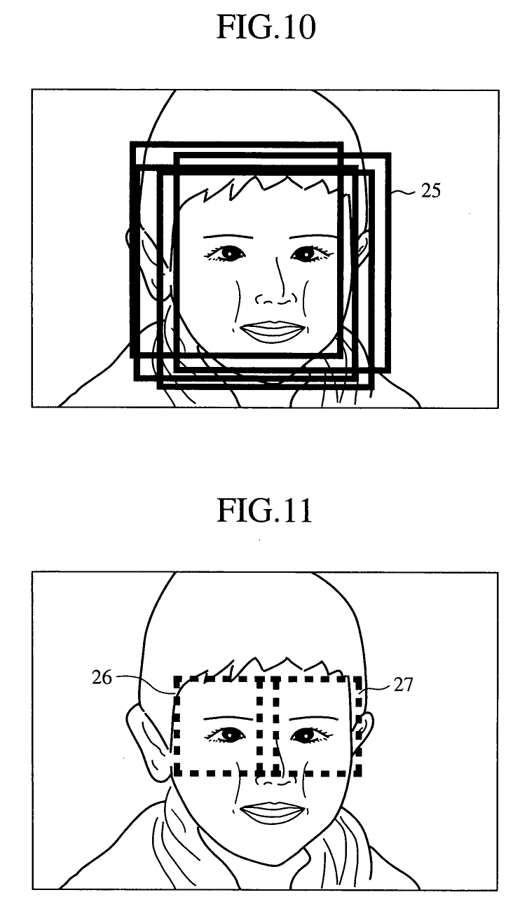

FIG. 10 is an explanatory diagram showing this detection processing, and shows detected results of face region.

Because two or more search blocks 25 in the figure are originally the one region, the rectangles which overlap one another are unified into a rectangle according to overlap ratios among them.

For example, when a rectangle 1 and a rectangle 2 overlap each other, an overlap ratio between them can be calculated using the following equation:
if the area of the rectangle 1>the area of the rectangle 2
the overlap ratio=the area of the part in which they overlap each other/the area of the rectangle 1 else
the overlap ratio=the area of the part in which they overlap each other/the area of the rectangle 2

When the overlap ratio is then larger than a threshold, the two rectangles are unified into one rectangle. When unifying the two rectangles into one rectangle, the face detecting means can calculate the average of the coordinates of the four vertexes of each of the two rectangles or can calculate the coordinates of the unified rectangle from a size relation between the coordinates of the four vertexes of one of the two rectangles and the coordinates of the four vertexes of the other one.

Next, the both eyes detecting means 4 detects both eyes from the face region which is obtained in the above-mentioned way (in step ST105).

In consideration of the features of human beings' faces, the both eyes detecting means can estimate the positions where the left eye and the right eye exist from the face region detected by the face detecting means 3.

The both eyes detecting means 4 specifies a search region for each of the both eyes from the coordinates of the face region, and detects the both eyes by focusing attention on the inside of the search region.

FIG. 11 is an explanatory diagram showing searching of both eyes. In the figure, reference numeral 26 denotes a left-eye search region, and reference numeral 27 denotes a right-eye search region.

The detection of both eyes can be also carried out through processing similar to the face detection in step ST104. The feature quantities of each of the left and right eyes are learned using Rectangle Filters so that, for example, the center of each of the both eyes is placed at the center of the corresponding search block. The both eyes detecting means then detects each of the both eyes while enlarging the search block, as in the case of steps ST201 to ST211 of the face detection.

When detecting the both eyes, the both eyes detecting means can end the processing when the size of the enlarged search block for each eye exceeds a certain search-region size of each eye. When searching for each of the eyes, it is dramatically inefficient to scan the search region from the pixel at the top-left vertex of the search region like the face detecting means 3. This is because the position of each of the eyes exists in the vicinity of the center of the search region which is determined in the above-mentioned way in many cases.

Therefore, the efficiency of the both eyes detection processing can be increased by scanning the search block for each of the eyes from the center thereof toward the perimeter of the search block and then interrupting the searching process when detecting each of the eyes.

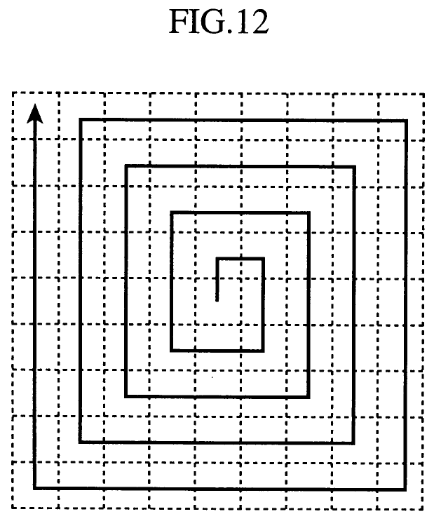

FIG. 12 is an explanatory diagram showing the process of searching for each of the eyes in the eye region.

In other words, the both eyes detecting means 4 carries out the process of searching for each of the eyes by scanning the search region of each of the both eyes in the detected face region from the center of the search region toward the perimeter of the search region so as to detect the position of each of the both eyes. In this embodiment, the both eyes detecting means searches for each of the eyes by spirally scanning the search region from the center of the search region toward the perimeter of the search region.

Next, the face identification apparatus normalizes the face image on the basis of the positions of the both eyes detected in step ST105 (in step ST106).

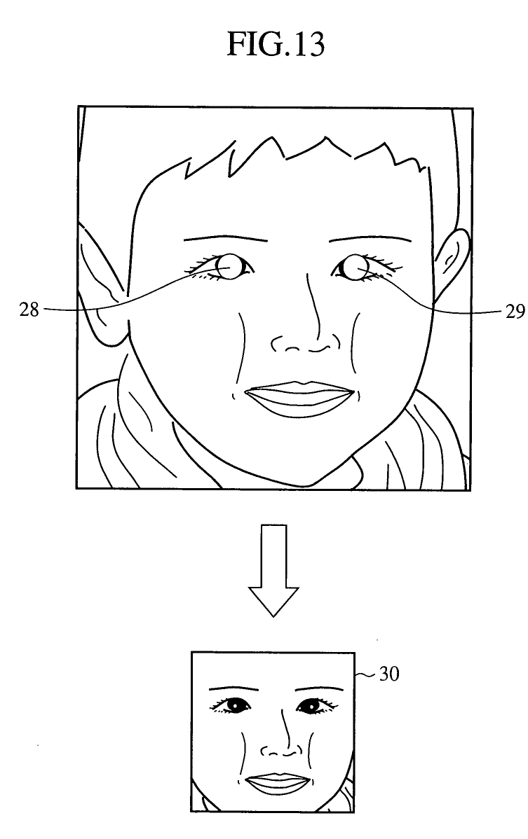

FIG. 13 is an explanatory diagram showing the normalization processing.

The face image normalizing means 5 extracts face feature quantities required for the face identification from the image in which the face region is enlarged or reduced so that it has an angle of field required for the face identification from the positions 28 and 29 of the both eyes detected by the both eyes detecting means 4.

In a case in which a normalized image 30 into which the image is to be normalized has an nw×nh-pixel size of nw pixels width and nh pixels height, and the position of the left eye and the position of the right eye are expressed by coordinates L(xl,yl) and R(xr,yr) in the normalized image 30, respectively, the following processing is carried out in order to normalize the detected face region into the set-up normalized image.

First, the face image normalizing means calculates a scaling factor.

When the positions of the detected both eyes are defined as DL(xdl,ydl) and DR(xdr,ydr), respectively, the scaling factor NS is calculated according to the following equation:

NS=((xr−xl+1)²+(yr−yl+1)²)/((xdr−xdl+1)²+(ydr−ydl+1)²)

Next, the face image normalizing means calculates the position of the normalized image in the original image, i.e., the position of the rectangle which is a target for face identification using the calculated scaling factor and information on the positions of the left eye and right eye set in the normalized image.

The coordinates of the top-left vertex and bottom-right vertex of the normalized image 30 are expressed in the form of positions relative to the position of the left eye as follows:
TopLeft(x,y)=(−xl,−yl)
BottomRight(x,y)=(nw−xl,nh−yl)

Therefore, the rectangular coordinates of the normalized image 30 in the original image are given by:

Rectangular top-left coordinates:
OrgNrImgTopLeft(x,y)=(xdl−xl/NS,ydl−yl/NS)
   Rectangular top-right coordinates:
OrgNrmImgBtmRight(x,y)=(xdl+(nw−xl)/NS,ydl+(nh−yl)/NS)

The face identification apparatus extracts feature quantities required for the face identification from the target for face identification which is determined in the above-mentioned way using a Rectangle Filter for face identification.

At that time, because the Rectangle Filter for face identification is designed assuming a normalized image size, the face identification apparatus can convert the coordinates of each rectangle in the Rectangle Filter into coordinates in the original image, as in the case of the face detection, can calculate the sum of the values of pixels in each rectangle on the basis of the integral image, and multiplies the calculated filter response by the scaling factor NS which is calculated in the above-mentioned way to calculate a filter response for the normalized image size.

First, the coordinates of each rectangle of the Rectangle Filter in the current image are given by:

OrgRgn(x,y)=(xdl+rx*Ns, ydl+ry*NS)

where rx and ry are the coordinates of each rectangle in the normalized image 30.

The face identification apparatus then refers to the values of all the pixels of the integral image from the coordinates of each rectangle calculated, and calculates the sum of the values of all pixels in each rectangle.

When the filter response in the original image is designated by FRorg and the response in the normalized image 30 is designated by FR, the following equation is established.

FR=FRorg*NS

Because there are plural Rectangle Filters required for the face identification, the face identification apparatus calculates a response for each of the plurality of Rectangle Filters (in step ST107). When registering a face, the face identification apparatus stores the responses for the plurality of Rectangle Filters in the feature quantity database 9 using the feature quantity storing means 7 (in steps ST108 and ST109).

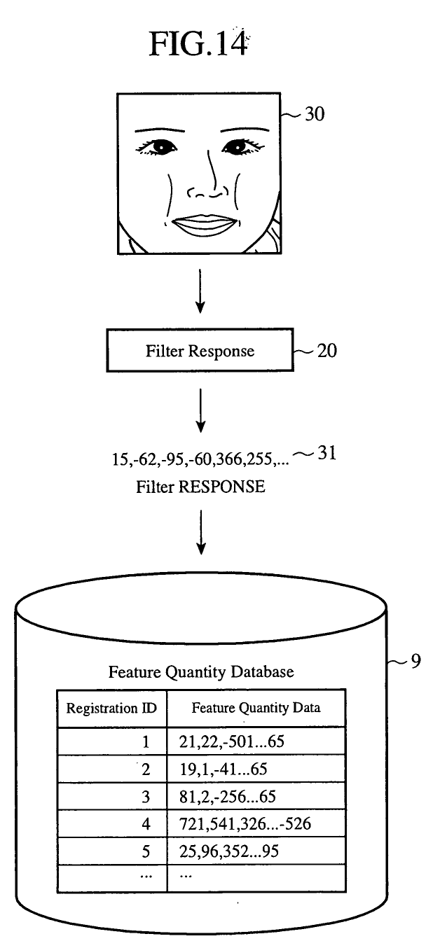

FIG. 14 is an explanatory diagram of the feature quantity database 9.

The feature quantity database 9 has a table structure which consists of registration IDs and feature quantity data as shown in the figure. In other words, the face identification apparatus calculates responses 31 for the plurality of Rectangle Filters 20 from the normalized image 30, and associates these responses 31 with a registration ID corresponding to an individual.

Next, a process of carrying out face identification using the face identification means 10 (steps ST110 and ST111 in FIG. 2) will be explained.

The face identification means carries out face identification by comparing the feature quantity extracted from the inputted image by the feature quantity acquiring means 6 with feature quantities stored in the feature quantity database 9.

Concretely, when the feature quantity of the inputted image is designated by RFc and a registered feature quantity is designated by RFr, a weight is given by the following equation 5 according to the difference between the feature quantities.

$$\{ \begin{matrix}R F {c}_{i} - R F {r}_{l , i} > th -> {w}_{i} = {pw}_{i} \\ R F {c}_{i} - R F {r}_{j , i} \leq th -> {w}_{i} = {nw}_{i}\end{matrix} \qquad [ Equation 5 ]$$

When the linear sum of weights thus obtained exceeds a threshold, the face identification means determines that the person is the same as the one having the registered feature quantity. That is, when the linear sum is designated by RcgV, the face identification means determines whether or not the person is the same as the one having the registered feature quantity according to the following equation 6.

$$RcgV = {\sum }_{i} {w}_{i} \\ \{ \begin{matrix}RcgV > th -> SamePerson \\ RcgV \leq th -> DifferentPerson\end{matrix} \qquad [ Equation 6 ]$$

Through the above-mentioned processing, the face identification apparatus can carry out storage of the feature quantities (registration processing) and face identification (face identification processing). In this embodiment, because the face identification apparatus carries out the above-mentioned processing, it can implement the processing in real time for example even if it is a mobile phone or a PDA.

In above-mentioned embodiment, the case where an integral image is used as the image for feature quantity extraction is explained. Instead of an integral image, for example, a multiplied image can be similarly used as the image for feature quantity extraction. A multiplied image can be obtained by multiplying the values of pixels of an original image running in the directions of the horizontal and vertical axes by one another. In other words, when the original gray-scale image is expressed as I(x, y), the multiplied image I′ (x, y) can be expressed by the following equation:

$${I}^{′} ( x , y ) = {\prod }_{{y}^{′} \leq y - 1} {\prod }_{{x}^{′} \leq x - 1} I ( {x}^{′} , {y}^{′} ) \qquad [ Equation 7 ]$$

When such a multiplied image is used as the image for feature quantity extraction, the response of each Rectangle Filter 20 is expressed by the following equation:

RF=π/(x_{w},y_{w})−πI(xₕ,yₕ) Equation 8

where I(x_{w},y_{w}) is the sum of the values of all pixels in one or more hollow rectangles, and I(x_{b},y_{b}) is the sum of the values of all pixels in one or more hatched rectangles.

Thus, when a multiplied image is used as the image for feature quantity extraction, the present embodiment can be applied to this case by making feature quantities have an expression corresponding to the multiplied image, as in the case in which an integral image as mentioned above is used as the image for feature quantity extraction.

Furthermore, an integral image in which each pixel has a value which is obtained by subtracting the values of pixels of the original image running in the directions of the horizontal and vertical axes from one another can be used, as the image for feature quantity extraction, instead of a multiplied image.

As mentioned above, the face identification apparatus in accordance with embodiment 1 includes: the feature-quantity-extraction image generating means for performing a predetermined operation on each pixel value of an inputted image so as to generate an image for feature quantity extraction; the face detecting means for detecting a face region including a person's face from the image for feature quantity extraction generated by the feature-quantity-extraction image generating means using learning data which have been obtained from learning of features of persons' face; the both eyes detecting means for detecting positions of the person's both eyes from the image for feature quantity extraction from which the face region is detected using learning data which have been obtained from learning of features of persons' both eyes; the feature quantity acquiring means for extracting a feature quantity from the image in which the face region is normalized on the basis of the positions of the person's both eyes; and the face identification means for comparing the feature quantity acquired by the feature quantity acquisition means with persons' feature quantities which are registered in advance so as to identify the person's face. Therefore, the face identification apparatus in accordance with this embodiment can implement the face identification processing accurately, and can reduce the amount of arithmetic operations.

Furthermore, in the face identification apparatus in accordance with embodiment 1, the face detecting means calculates a feature quantity from a difference between sums of values of pixels in specific rectangles in a predetermined search window of the image for feature quantity extraction, and carries out the detection of the person's face on a basis of the result, the both eyes detecting means calculates a feature quantity from a difference between sums of values of pixels in specific rectangles in a predetermined search window of the image for feature quantity extraction, and carries out the detection of the person's both eyes on a basis of the result, and the face identification means carries out the identification of the person's face using a result of obtaining a feature quantity from a difference between sums of values of pixels in specific rectangles in a predetermined search window of the image for feature quantity extraction. Therefore, the face identification apparatus in accordance with this embodiment can calculate the feature quantities correctly with a small amount of arithmetic operations. Furthermore, the face identification apparatus can provide improved processing efficiency because it carries out face detection, both eyes detection, and face identification processing on the basis of the image for feature quantity extraction which it has obtained.

In addition, in the face identification apparatus in accordance with embodiment 1, the feature-quantity-extraction image generating means generates, as the image for feature quantity extraction, an image in which each pixel has a value which is obtaining by adding or multiplying values of pixels of the image running in directions of axes of coordinates. Therefore, the sum of the values of all pixels in, for example, an arbitrary rectangle can be calculated using only calculation results at four points, and the feature quantities can be calculated efficiently with a small amount of arithmetic operations.

Furthermore, in the face identification apparatus in accordance with embodiment 1, the face detecting means enlarges or reduces the search window, normalizes the feature quantity according to a scaling factor associated with the enlargement or reduction, and detects the face region. Therefore, it is not necessary to acquire two or more images having different resolutions, and an image for feature quantity extraction for each of the different resolutions, and this results in an improvement in the memory efficiency.

In addition, in the face identification apparatus in accordance with embodiment 1, the feature-quantity-extraction image generating means calculates an image for feature quantity extraction for each of image parts into which the image is split so that arithmetic operation values of the image for feature quantity extraction can be expressed. Thus, when the inputted image has a large size, the feature-quantity-extraction image generating means can prevent each pixel value of the integral image from overflowing by dividing the image into several parts when calculating an image for feature quantity extraction. Therefore, the face identification apparatus in accordance with this embodiment can support any input image size.

The face identification method in accordance with embodiment 1 includes: the feature-quantity-extraction image generating step of performing a predetermined operation on each pixel value of an inputted image so as to generate image data for feature quantity extraction; the face detecting step of detecting a face region including a person's face from the image data for feature quantity extraction using learning data which have been obtained from learning of features of persons' face; the both eyes detecting step of detecting positions of the person's both eyes from the image data for feature quantity extraction from which the face region is detected using learning data which have been obtained from learning of features of persons' both eyes; the feature quantity acquiring step of extracting a feature quantity from the image data which is normalized on a basis of the positions of the person's both eyes; and the face identification step of comparing the feature quantity acquired in the feature quantity acquisition step with persons' feature quantities which are registered in advance so as to identify the person's face. Therefore, using the face identification method in accordance with this embodiment, the face identification processing can be performed on any inputted image accurately, and the face identification processing can be carried out with a small amount of arithmetic operations.

The face identification apparatus in accordance with embodiment 1 includes: the face detecting means for detecting a face region including a person's face from an inputted image; the both eyes detecting means for performing a search from a center of a both-eyes search region in the detected face region toward a perimeter of the both-eyes search region so as to detect positions of the person's both eyes; the feature quantity acquiring means for extracting a feature quantity from the image in which the face region is normalized on a basis of the positions of the person's both eyes; and the face identification means for comparing the feature quantity acquired by the feature quantity acquisition means with persons' feature quantities which are registered in advance so as to identify the person's face. Therefore, the face identification apparatus in accordance with this embodiment can reduce the amount of arithmetic operations required for the both eyes search processing. As a result, the face identification apparatus can improve the efficiency of the face identification processing.

The face identification method in accordance with embodiment 1 includes: the face detecting step of detecting a face region including a person's face from inputted image data; the both eyes detecting step of performing a search from a center of a both-eyes search region in the detected face region toward a perimeter of the both-eyes search region so as to detect positions of the person's both eyes; the feature quantity acquiring step of extracting a feature quantity from the image data in which the face region is normalized on a basis of the positions of the person's both eyes; and the face identification step of comparing the feature quantity acquired in the feature quantity acquisition step with persons' feature quantities which are registered in advance so as to identify the person's face. Therefore, the face identification method in accordance with this embodiment can reduce the amount of arithmetic operations required for the both eyes search processing. As a result, the face identification method can improve the efficiency of the face identification processing.

### INDUSTRIAL APPLICABILITY

As mentioned above, the face identification apparatus and face identification method in accordance with the present invention are provided to carry out face identification by comparing an inputted image with images registered in advance, and are suitable for use in various security systems which carry out face identification.

1. A face identification apparatus comprising:
a feature-quantity-extraction image generating means for performing a predetermined operation on each pixel value of an inputted image so as to generate an image for feature quantity extraction;
a face detecting means for detecting a face region including a person's face from the image for feature quantity extraction generated by said feature-quantity-extraction image generating means using learning data which have been obtained from learning of features of persons' face;
a both eyes detecting means for detecting positions of the person's both eyes from said image for feature quantity extraction from which the face region is detected using learning data which have been obtained from learning of features of persons' both eyes;
a feature quantity acquiring means for extracting a feature quantity from the image in which said face region is normalized on a basis of the positions of the person's both eyes; and
a face identification means for comparing the feature quantity acquired by said feature quantity acquisition means with persons' feature quantities which are registered in advance so as to identify the person's face.

2. The face identification apparatus according to claim 1, wherein the face detecting means calculates a feature quantity from a difference between sums of values of pixels in specific rectangles in a predetermined search window of the image for feature quantity extraction, and carries out the detection of the person's face on a basis of the result, the both eyes detecting means calculates a feature quantity from a difference between sums of values of pixels in specific rectangles in a predetermined search window of said image for feature quantity extraction, and carries out the detection of the person's both eyes on a basis of the result, and the face identification means carries out the identification of the person's face using a result of obtaining a feature quantity from a difference between sums of values of pixels in specific rectangles in a predetermined search window of said image for feature quantity extraction.

3. The face identification apparatus according to claim 1, wherein the feature-quantity-extraction image generating means generates, as the image for feature quantity extraction, an image in which each pixel has a value which is obtaining by adding or multiplying values of pixels of the image running in directions of axes of coordinates together or by one another.

4. The face identification apparatus according to claim 1, wherein the face detecting means enlarges or reduces the search window, normalizes the feature quantity according to a scaling factor associated with the enlargement or reduction, and detects the face region.

5. The face identification apparatus according to claim 1, wherein the feature-quantity-extraction image generating means calculates an image for feature quantity extraction for each of image parts into which the image is split so that arithmetic operation values of said image for feature quantity extraction can be expressed.

6. A face identification method comprising:
a feature-quantity-extraction image generating step of performing a predetermined operation on each pixel value of an inputted image so as to generate image data for feature quantity extraction;
a face detecting step of detecting a face region including a person's face from said image data for feature quantity extraction using learning data which have been obtained from learning of features of persons' face;
a both eyes detecting step of detecting positions of the person's both eyes from said image data for feature quantity extraction from which the face region is detected using learning data which have been obtained from learning of features of persons' both eyes;
a feature quantity acquiring step of extracting a feature quantity from the image data which is normalized on a basis of the positions of the person's both eyes; and
a face identification step of comparing the feature quantity acquired in said feature quantity acquisition step with persons' feature quantities which are registered in advance so as to identify the person's face.

7. A face identification apparatus comprising:
a face detecting means for detecting a face region including a person's face from an inputted image;
a both eyes detecting means for performing a search from a center of a both-eyes search region in the detected face region toward a perimeter of the both-eyes search region so as to detect positions of the person's both eyes;
a feature quantity acquiring means for extracting a feature quantity from the image in which said face region is normalized on a basis of the positions of the person's both eyes; and
a face identification means for comparing the feature quantity acquired by said feature quantity acquisition means with persons' feature quantities which are registered in advance so as to identify the person's face.

8. A face identification method comprising:
a face detecting step of detecting a face region including a person's face from inputted image data;
a both eyes detecting step of performing a search from a center of a both-eyes search region in the detected face region toward a perimeter of the both-eyes search region so as to detect positions of the person's both eyes;
a feature quantity acquiring step of extracting a feature quantity from the image data in which said face region is normalized on a basis of the positions of the person's both eyes; and
a face identification step of comparing the feature quantity acquired in said feature quantity acquisition step with persons' feature quantities which are registered in advance so as to identify the person's face.
